(19) United States
(12) Patent Application Publication
(10) Pub. No.: US 2023/0214394 A1
(43) Pub. Date: Jul. 6, 2023

(54) DATA SEARCH METHOD AND APPARATUS, ELECTRONIC DEVICE AND STORAGE MEDIUM

(71) Applicant: BEIJING WENJINGSONG TECHNOLOGY CO., LTD., Bejing (CN)

(72) Inventor: Wensong HE, Beijing (CN)

(21) Appl. No.: 17/966,117

(22) Filed: Oct. 14, 2022

(30) Foreign Application Priority Data
Dec. 28, 2021 (CN) 202111620913.X

(51) Int. Cl. G06F 16/2455

(52) U.S. Cl. CPC G06F 16/24561; G06F 16/24557

(57) ABSTRACT

Provided are a data search method and apparatus, an electronic device and a storage medium. The method includes acquiring search data and a search condition and determining a target data set corresponding to the search data; determining each data distance between the search data and a respective query datum included in the target data set; performing data filtering on the each data distance based on the search condition and writing each filtered data distance as a target data distance into a memory; and reading the target data distance stored in the memory, using a query datum corresponding to the target data distance as a target response datum of the search data and displaying the target response datum.

### CROSS-REFERENCE TO RELATED APPLICATION(S)

This application claims priority to Chinese Patent Application No. 202111620913X filed Dec. 28, 2021, the disclosure of which is incorporated herein by reference in its entirety.

### TECHNICAL FIELD

Embodiments of the present disclosure relate to the field of data processing technologies and, in particular, to a data search method and apparatus, an electronic device and a storage medium.

### BACKGROUND

At present, in a data search method, it is generally required to calculate the data distance between reference data and each search data and then obtain, based on the data distance, data satisfying the search condition. However, in the related art, after the data distance between reference data and each search datum is calculated, all the data distances obtained by calculation need to be written into a memory, and in the process of obtaining, based on the data distance, data satisfying the search condition, all the data distances in the memory need to be read to obtain the data satisfying the search condition. Therefore, in the data search process, the existing data search methods not only require frequent reading and writing operations on the memory, but also have the technical problem of excessive memory occupation.

### SUMMARY

Embodiments of the present disclosure provide a data search method and apparatus, an electronic device and a storage medium to reduce the number of reading and writing operations on the memory and the memory occupation in a data search process.

In a first aspect, embodiments of the present disclosure provide a data search method. The method includes the steps below.

Search data and a search condition are acquired, and a target data set corresponding to the search data is determined.

Each data distance between the search data and a respective query datum included in the target data set is determined.

Data filtering is performed on the each data distance based on the search condition, and each filtered data distance as a target data distance is written into a memory.

The target data distance stored in the memory is read, a query datum corresponding to the target data distance is used as a target response datum of the search data, and the target response datum is displayed.

In a second aspect, embodiments of the present disclosure further provide a data search apparatus. The apparatus includes a target data set determination module, a data distance determination module, a target data distance write module and a target response data display module.

The target data set determination module is configured to obtain search data and a search condition and determine a target data set corresponding to the search data.

The data distance determination module is configured to determine each data distance between the search data and a respective query datum included in the target data set.

The target data distance write module is configured to perform data filtering on the each data distance based on the search condition and write each filtered data distance as a target data distance into a memory.

The target response data display module is configured to read the target data distance stored in the memory, use a query datum corresponding to the target data distance as a target response datum of the search data and display the target response datum.

In a third aspect, embodiments of the present disclosure further provide an electronic device. The electronic device includes one or more processors and a storage device.

The storage device is configured to store one or more programs.

When executed by the one or more processors, the one or more programs cause the one or more processors to perform the data search method according to any embodiment of the present disclosure.

In a fourth aspect, embodiments of the present disclosure further provide a non-transitory computer-readable storage medium storing a computer program which, when executed by a processor, causes the processor to perform the data search method according to any embodiment of the present disclosure.

### BRIEF DESCRIPTION OF DRAWINGS

To illustrate the technical solutions in the exemplary embodiments of the present disclosure more clearly, the drawings used in the embodiments will be described below. Apparently, the drawings described below are part, not all, of the drawings of the embodiments of the present disclosure. Those of ordinary skill in the art may obtain other drawings based on the drawings described below on the premise that no creative work is done.

FIG. 1 is a flowchart of a data search method according to embodiment one of the present disclosure.

FIG. 2 is a flowchart of a data search method according to embodiment two of the present disclosure.

FIG. 3 is a flowchart of a data search method according to embodiment three of the present disclosure.

FIG. 4 is a diagram illustrating the structure of a data search apparatus according to embodiment four of the present disclosure.

FIG. 5 is a diagram illustrating the structure of an electronic device according to embodiment five of the present disclosure.

### DETAILED DESCRIPTION

Hereinafter the present disclosure will be further described in detail in conjunction with the drawings and embodiments. It is to be understood that the specific embodiments set forth below are intended to illustrate and not to limit the present disclosure. Additionally, it is to be noted that for ease of description, only part, not all, of the structures related to the present disclosure are illustrated in the drawings.

### Embodiment One

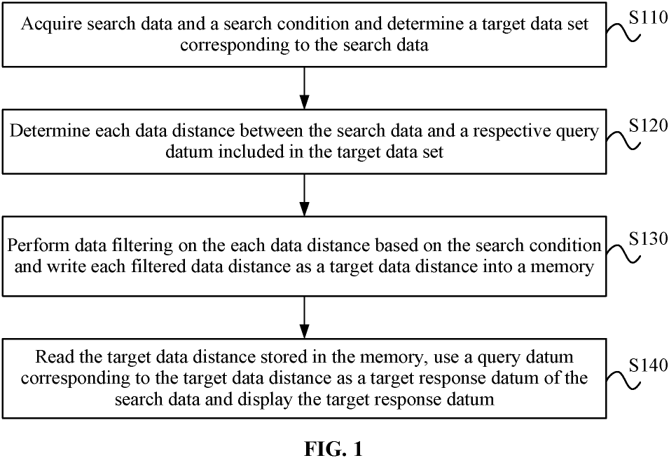

FIG. 1 is a flowchart of a data search method according to embodiment one of the present disclosure. The present embodiment is applicable to a data search case. The method may be executed by a data search apparatus. The apparatus may be implemented by software and/or hardware and may be integrated in an electronic device, such as a computer or a server.

As shown in FIG. 1, the method in the present embodiment includes the steps below.

In S110, search data and a search condition are acquired, and a target data set corresponding to the search data is determined.

The search condition may be a condition for performing data search. The search data may be data input by a user. The number of search data may be one or more. The search data may include any one of image data, audio data, or text data. The target data set may be a data set that provides data for the current data search operation.

In an embodiment, the search condition and the search data are acquired. After the search data is acquired, the search data can be determined. Further, the target data set corresponding to the search data can be determined according to the search data. It is to be noted that there are multiple manners to acquire the search condition, and the specific set manner is not limited here. For example, the condition input by the user for data search may be used as the search condition, or the search condition may be obtained by parsing a search request. The search request may be a request generated based on the user operation.

In S120, each data distance between the search data and a respective query datum included in the target data set is determined.

The query data may be data included in the target data set. The number of query data may be one or more. The data distance may be a distance between the search data and the respective query datum.

In an embodiment, a calculation formula for calculating a data distance is preset. For the respective query datum included in the target data set, the each data distance between the respective query datum and the search data may be calculated by the preset calculation formula for calculating a data distance. Therefore, the each data distance between the search data and the respective query datum can be determined.

It is to be noted that the preset calculation formula for calculating a data distance may be configured according to actual needs, and the specific formula is not limited here. For example, the preset calculation formula for calculating a data distance may be a Euclidean distance calculation formula, a cosine calculation formula, an inner product calculation formula, a Jaccard distance calculation formula, a Tanimoto distance calculation formula, or a Hamming distance calculation formula.

In S130, data filtering is performed on the each data distance based on the search condition, and each filtered data distance as a target data distance is written into a memory.

The target data distance may be a data distance obtained by performing the data filtering on the each data distance. The number of target data distances may be one or more.

In an embodiment, after the each data distance between the search data and the respective query datum is determined, the data filtering can be performed on the each data distance based on the search condition. Therefore, the each filtered data distance can be obtained and used as the target data distance. That is, the target data can be obtained. After being obtained, the target data can be written into the memory.

In S140, the target data distance stored in the memory is read, a query datum corresponding to the target data distance is used as a target response datum of the search data, and the target response datum is displayed.

The target response datum may be a query datum satisfying the search condition. The number of target response data may be one or more.

In an embodiment, after the target data distance is written into the memory, the target data distance stored in the memory can be read. Therefore, the query datum corresponding to the target data distance can be determined and used as the target response datum of the search data. After being determined, the target response datum can be displayed.

In an embodiment, the search condition may include the data similarity between the search data and the target response datum. In the following manner, the data filtering is performed on the each data distance based on the search condition, and the each filtered data distance as the target data distance is written into the memory.

The data similarity is used as the first filtering distance threshold, and each data distance greater than or equal to or less than or equal to the first filtering distance threshold as the target data distance is written into the memory.

The first filtering distance threshold may be the data similarity between the search data and the target response datum. The data similarity between the search data and the target response datum may be a numerical value input by the user, and the specific numerical value is not limited here, for example, 0.2, 0.5, or 1.0.

In an embodiment, input by the user, the data similarity between the search data and the target response datum may be received. Therefore, the received data similarity can be used as the first filtering distance threshold. That is, the first filtering distance threshold is determined. After the first filtering distance threshold is determined, the each data distance less than or equal to or greater than or equal to the first filtering distance threshold can be determined and then used as the target data distance. That is, the target data distance is determined. After being determined, the target data distance can be written into the memory. It is to be noted that whether each data distance less than or equal to the first filtering distance threshold is used as the target data distance or each data distance greater than or equal to the first filtering distance threshold is used as the target data distance may be determined according to the user’s actual needs and is not limited here.

In the technical solution in the present embodiment of the present disclosure, the search data and the search condition are acquired. Therefore, the target data set corresponding to the search data can be determined according to the search data. After the target data set is determined, the each data distance between the search data and the respective query datum included in the target data set can be determined. After the each data distance is determined, the data filtering can be performed on the each data distance based on the search condition to obtain the each filtered data distance. After being obtained, the each filtered data distance as the target data distance can be written into the memory. After the target data distance is written into the memory, the target data distance stored in the memory can be read. After the target data distance is read, the query datum corresponding to the target data distance can be used as the target response datum of the search data, and the target response datum can be displayed. In this manner, the data can be searched, that in the data search process, the existing data search methods not only require frequent reading and writing operations on the memory, but also have the technical problem of excessive memory occupation can be solved, and the number of reading and writing operations on the memory and the memory occupation in the data search process can be reduced.

### Embodiment Two

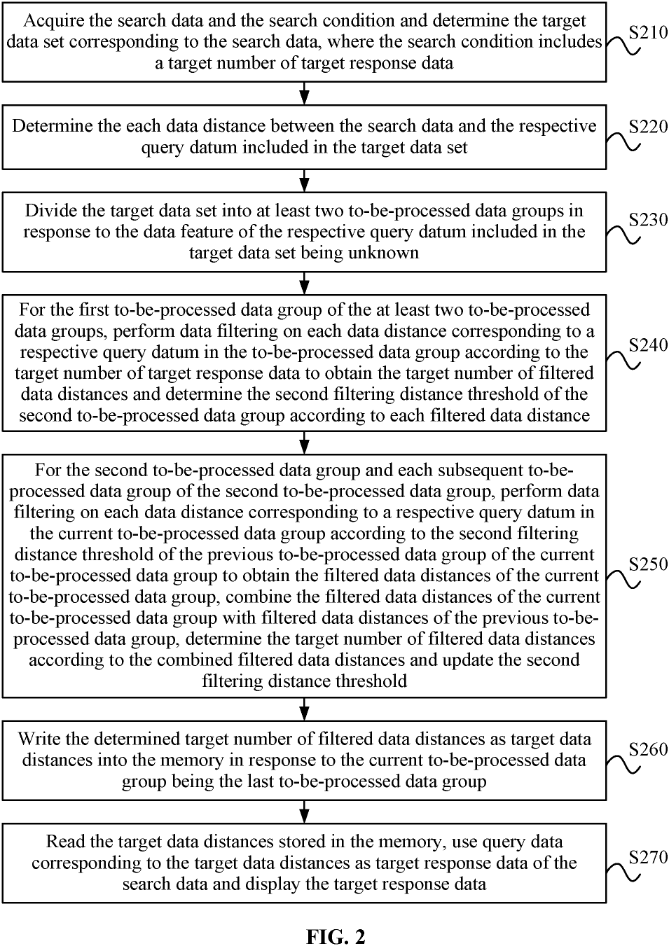

FIG. 2 is a flowchart of a data search method according to embodiment two of the present disclosure. Based on the preceding embodiment, optionally, the search condition includes a target number of target response data, and that data filtering is performed on the each data distance based on the search condition, and the each filtered data distance as the target data distance is written into the memory includes the following: The target data set is divided into at least two to-be-processed data groups in response to the data feature of the respective query datum included in the target data set being unknown; for the first to-be-processed data group of the at least two to-be-processed data groups, date filtering is performed on each data distance corresponding to a respective query datum in the to-be-processed data group according to the target number of target response data to obtain the target number of filtered data distances, and the second filtering distance threshold of the second to-be-processed data group is determined according to each filtered data distance; for the second to-be-processed data group and each subsequent to-be-processed data group of the second to-be-processed data group, data filtering is performed on each data distance corresponding to a respective query datum in the current to-be-processed data group according to the second filtering distance threshold of the previous to-be-processed data group of the current to-be-processed data group to obtain filtered data distances of the current to-be-processed data group, the filtered data distances of the current to-be-processed data group are combined with filtered data distances of the previous to-be-processed data group, the target number of filtered data distances are determined according to the combined filtered data distances, and the second filtering distance threshold is updated; and the determined target number of filtered data distances as the target data distances are written into the memory in response to the current to-be-processed data group being the last to-be-processed data group. Technical terms identical to or corresponding to the preceding embodiment are not repeated here.

As shown in FIG. 2, the method in the present embodiment may specifically include the steps below.

In S210, the search data and the search condition are acquired, and the target data set corresponding to the search data is determined, where the search condition includes a target number of target response data.

The target number may be a number configured according to the user’s needs, and the specific value is not limited here, for example, may be 100, 500, or 900.

In an embodiment, the search condition and the search data that are input by the user are received. After the search condition are received, the target number of target response data can be determined based on the search condition. After the search data is received, the data set corresponding to the search data can be determined according to the search data and can be further used as the target data set.

In S220, the each data distance between the search data and the respective query datum included in the target data set is determined.

In S230, the target data set is divided into at least two to-be-processed data groups in response to the data feature of the respective query datum included in the target data set being unknown.

The target data set may include multiple types of query data. The at least two to-be-processed data groups may be data groups obtained by grouping the target data set.

In an embodiment, if the data feature of the respective query datum included in the target data set is unknown, the query data included in the target data set are grouped. Therefore, the target data set can be divided into the at least two to-be-processed data groups.

In an embodiment, the target data set is divided into the at least two to-be-processed data groups in the following manner.

The target data set is divided into the at least two to-be-processed groups according to the number of query data in the target data set.

The number of query data may be a number configured according to actual needs. The number of query data may be the number of query data included in each to-be-processed data group. The number of query data included in the each to-be-processed data group may be the same or different.

In an embodiment, the number of query data included in the each to-be-processed data group is preset. The query data of the target data set can be grouped according to the preset number of query data included in the each to-be-processed data group so that the target data set can be divided into the at least two to-be-processed data groups.

It is to be noted that in the present embodiment of the present disclosure, the number of query data included in the each to-be-processed data group may be different. The advantage is that the processing efficiency of data can be improved.

In an embodiment, the number of query data included in the each to-be-processed group is determined in the following manner.

The number of query data included in the first to-be-processed data group is preset. The number of query data included in other to-be-processed data groups other than the first to-be-processed data group is determined according to the preset number of query data included in the first to-be-processed data group.

It is to be noted that the number of query data included in the first to-be-processed data group is between the target number of target response data and the number of query data included in the target data set and is far smaller than the number of query data included in the target data set.

In an embodiment, the number of query data included in other to-be-processed data groups other than the first to-be-processed data group is determined according to the preset number of query data included in the first to-be-processed data group in the following manner.

An extraction multiple is preset for the second to-be-processed data group and each subsequent to-be-processed data group of the second to-be-processed data group. The number of query data included in the previous to-be-processed data group is determined. Therefore, the number of query data included in the previous to-be-processed data group can be multiplied by the preset multiple to obtain the result of product calculation. The product result is used as the number of query data included in the current to-be-processed data group. The preset extraction multiple may be preset according to actual needs.

Exemplarily, the extraction multiple is preset as 2. The number of query data included in the first to-be-processed data group is preset as 2048. Then, the number of query data included in the second to-be-processed data group is 2048 × 2 = 4096, and the number of query data included in the third to-be-processed data group is 4096 × 2 = 8192.

Further, to improve the efficiency of data search, an extraction multiple corresponding to each to-be-processed data group may be preset for the each to-be-processed data group. It is to be understood that the extraction multiple corresponding to the each to-be-processed data group may be the same or different. For example, the extraction multiple corresponding to the second to-be-processed data group is 2, the extraction multiple corresponding to the third to-be-processed data group is 2, the extraction multiple corresponding to the fourth to-be-processed data group is 2, the extraction multiple corresponding to the fifth to-be-processed data group is 3, and the extraction multiple corresponding to the last to-be-processed data group is 3.

In the present embodiment of the present disclosure, the extraction multiple corresponding to the second to-be-processed data group is 1, and the extraction multiple corresponding to the third to-be-processed data group and the fourth to-be-processed data group until the last to-be-processed data group is 2. Exemplarily, when the number of query data included in the first to-be-processed data group is preset as 2048, the number of query data included in the second to-be-processed data group is 2048, the number of query data included in the third to-be-processed data group is 2048 × 2 = 4096, and the number of the query data included in the fourth to-be-processed data group is 4096 × 2 = 8192. The advantage of configuring the extraction multiples in this way is that the number of query data processed at the current time can be consistent with the number of query data processed before the current time so that the technical problem that there is a large difference in the numbers of filtered data between adjacent filtering operations after data filtering can be avoided.

In S240, for the first to-be-processed data group of the at least two to-be-processed data groups, data filtering is performed on each data distance corresponding to a respective query datum in the current to-be-processed data group according to the target number of target response data to obtain the target number of filtered data distances; and the second filtering distance threshold of the second to-be-processed data group is determined according to each filtered data distance.

The second filtering distance threshold may be a threshold used for performing the data filtering on the each data distance corresponding to the respective query datum included in the to-be-processed data group.

In an embodiment, for the first to-be-processed data group, the data filtering is performed on the each data distance corresponding to the respective each query datum in the first to-be-processed data group according to the target number of target response data to obtain the target number of filtered data distances. That is, each filtered data distance can be obtained. After the each filtered data distance is obtained, the second filtering distance threshold of the second to-be-processed data group can be determined according to the each filtered data distance.

In an embodiment, how to perform the data filtering on the each data distance corresponding to the respective query datum of the to-be-processed data group according to the target number of target response data to obtain the target number of filtered data distances and determine the second filtering distance threshold of the second to-be-processed data group according to the each filtered data distance is introduced in the following steps.

In step one, the data distances corresponding to the query data in the to-be-processed data group are sorted in a descending order or an ascending order.

In an embodiment, the data distances corresponding to the query data included in the first to-be-processed data group are sorted in the descending order or the ascending order to obtain the sorted data distances.

In step two: the data filtering is performed on the sorted data distances based on the target number of target response data to obtain the target number of filtered data distances, and the second filtering distance threshold of the second to-be-processed data group is determined according to each filtered data distance.

In an embodiment, after the sorted data distances are obtained, the data filtering can be performed on the sorted data distances based on the target number of target response data to obtain the target number of filtered data distances. That is, each filtered data distance can be obtained. After the each filtered data distance is obtained, the second filtering distance threshold of the second to-be-processed data group can be determined according to the each filtered data distance.

How to perform the data filtering on the sorted data distances based on the target number of target response data to obtain the target number of filtered data distances and determine the second filtering distance threshold of the second to-be-processed data group according to the each filtered data distance is introduced in the two following manners.

Manner one: in response to the data distances of the query data in the to-be-processed data group being sorted in the descending order, the target number of top-ranked data distances among the sorted data distances are used as the target number of filtered data distances of the to-be-processed data group, and a data distance having the minimum value among the sorted data distances of the to-be-processed data group is used as the second filtering distance threshold of the second to-be-processed data group.

Exemplarily, when the data distances corresponding to the query data in the first to-be-processed data group after sorting is 5, 4, 3, 2, 1, and the target number is 2, the target number of filtered data distances in the first to-be-processed data group are 5 and 4, where 4 is the second filtering distance threshold of the second to-be-processed data group.

Manner two: in response to the data distances of the query data in the to-be-processed data group being sorted in the ascending order, the target number of top-ranked data distances among the sorted data distances are used as the target number of filtered data distances of the to-be-processed data group, and the data distance having the maximum value among the sorted data distances of the to-be-processed data group is used as the second filtering distance threshold of the second to-be-processed data group.

Exemplarily, when the data distances corresponding to the query data in the first to-be-processed data group after sorting is 1, 2, 3, 4, 5, and the target number is 2, the target number of filtered data distances of the first to-be-processed data group are 1 and 2, where 2 is the second filtering distance threshold of the second to-be-processed data group.

In S250, for the second to-be-processed data group and each subsequent to-be-processed data group of the second to-be-processed data group, data filtering is performed on each data distance corresponding to a respective query datum in the current to-be-processed data group according to the second filtering distance threshold of the previous to-be-processed data group of the current to-be-processed data group to obtain the filtered data distances of the current to-be-processed data group, the filtered data distances of the current to-be-processed data group are combined with filtered data distances of the previous to-be-processed data group, the target number of filtered data distances are determined according to the combined filtered data distances, and the second filtering distance threshold is updated.

In an embodiment, the second filtering distance threshold of the previous to-be-processed data group of the current to-be-processed data group is determined for the second to-be-processed data group and each subsequent to-be-processed data group of the second to-be-processed data group. Therefore, the data filtering can be performed on the each data distance corresponding to the respective query datum in the current to-be-processed data group according to the second filtering distance threshold of the previous to-be-processed data group of the current to-be-processed data group to obtain the filtered data distances of the current to-be-processed data group. After the filtered data distances of the current to-be-processed data group are obtained, the filtered data distances are combined with the filtered data distances of the previous to-be-processed data group to obtain the combined filtered data distances. After the combined filtered data distances are obtained, the target number of filtered data distances can be determined according to the combined filtered data distances. Therefore, the second filtering distance threshold can be updated according to the determined target number of filtered data distances.

The advantage of performing the data filtering on the each data distance corresponding to the respective query datum in the to-be-processed data group according to the second filtering distance threshold of the previous to-be-processed data group is that the number of times of sorting can be reduced so that the duration required for data processing can be shortened.

It is to be noted that in response to the data distances of the query data in the to-be-processed data group being sorted in the descending order, the target number of top-ranked data distances among the sorted data distances are used as the target number of filtered data distances of the to-be-processed data group, and the data distance having the minimum value among the sorted data distances of the to-be-processed data group is used as the second filtering distance threshold of the second to-be-processed data group. Then, that the data filtering is performed on the each data distance corresponding to the respective query datum in the to-be-processed data group according to the second filtering distance threshold of the previous to-be-processed data group may be obtaining each data distance corresponding to a respective query datum in the to-be-processed data group exceeding the second filtering distance threshold of the previous to-be-processed data group. Then, of the current to-be-processed data group, the query datum corresponding to a relatively large data distance from the search data can be determined. Alternatively, it may be obtaining each data distance corresponding to a respective query datum in the to-be-processed data group not exceeding the second filtering distance threshold of the previous to-be-processed data group. Then, of the current to-be-processed data group, the query datum corresponding to a relatively small data distance from the search data can be determined.

To reduce the duration required for sorting, the sorting number of the filtered data distances included in each sorting may be preset. After the filtered data distances of the to-be-processed data group are obtained, if the number of obtained filtered data distances of the to-be-processed data group does not reach the preset sorting number, the data filtering may continue to be performed on each data distance corresponding to a respective query datum in the next to-be-processed data group of the to-be-processed data group based on the current second filtering distance threshold; if the number of obtained filtered data distances of the to-be-processed data group reaches the preset number, the filtered data distances of the to-be-processed data group reaching the preset number are sorted. The sorted filtered data distances are combined with the previous filtered data distances stored in the memory. After the combination, the combined filtered data distances can be obtained. After the combined filtered data distances are obtained, the target number of filtered data distances can be determined according to the combined filtered data distances. Therefore, the second filtering distance threshold can be updated according to the determined target number of filtered data distances.

To read and manage the filtered data distances corresponding to the query data in each to-be-processed data group more quickly, a queue may be pre-created. After being obtained, the filtered data distances may be stored into the pre-created queue. Correspondingly, before the filtered data distances are combined with the filtered data distances of the previous to-be-processed data group, the filtered data distances of the previous to-be-processed group of the current to-be-processed data group may be read from the pre-created queue to facilitate effective data processing on the filtered data distances.

In S260, the determined target number of filtered data distances as target data distances are written into the memory in response to the current to-be-processed data group being the last to-be-processed data group.

In an embodiment, in response to the current to-be-processed data group being the last to-be-processed data group, the previous to-be-processed data group of the last to-be-processed data group can be determined. Therefore, the second filtering distance threshold corresponding to the previous to-be-processed data group of the last to-be-processed data group can be determined. After the second filtering distance threshold corresponding to the previous to-be-processed data group of the last to-be-processed data group is determined, the data distances corresponding to the query data included in the last to-be-processed data group can be filtered according to the second filtering distance threshold corresponding to the previous to-be-processed data group of the last to-be-processed data group to obtain the filtered data distances of the last to-be-processed data group. After the filtered data distances of the last to-be-processed data group are obtained, the filtered data distances of the last to-be-processed data group can be combined with the filtered data distances of the previous to-be-processed data group of the last to-be-processed data group to obtain the combined filtered data distances. After the combined filtered data distances are obtained, the target number of filtered data distances can be determined according to the combined filtered data distances.

In S270, the target data distances stored in the memory are read, query data corresponding to the target data distances is used as target response data of the search data, and the target response data is displayed.

It is to be noted that if the target data set includes at least two data clusters, for each data cluster, the data family satisfying the search condition may be determined based on the data distance between the center point of the each data cluster and the search data and may be used as the target data cluster. Therefore, based on the data distance between the query data included in the target data cluster and the search data, the query data satisfying the search condition in the target data cluster can be determined and used as the target response data of the search data.

In the technical solution in the present embodiment of the present disclosure, the search condition includes the target number of target response data. The target data set is divided into the at least two to-be-processed data groups in response to the data feature of the respective query datum included in the target data set being known; for the first to-be-processed data group of the at least two to-be-processed data groups, the data filtering is performed on the each data distance corresponding to the respective query datum in the to-be-processed data group according to the target number of target response data to obtained the target number of filtered data distances, and the second filtering distance threshold of the second to-be-processed data group is determined according to each filtered data distance; for the second to-be-processed data group and each subsequent to-be-processed data group of the second to-be-processed data group, the data filtering is performed on the each data distance corresponding to the respective query datum in the current to-be-processed data group according to the second filtering distance threshold of the previous to-be-processed data group of the current to-be-processed data group to obtain the filtered data distances of the current to-be-processed data group, the filtered data distances of the current to-be-processed data group are combined with the filtered data distances of the previous to-be-processed data group, the target number of filtered data distances are determined according to the combined filtered data distances, and the second filtering distance threshold is updated; the determined target number of filtered data distances as the target data distances are written into the memory in response to the current to-be-processed data group being the last to-be-processed data group. In this manner, that in the data search process, the existing data search methods not only require frequent reading and writing operations on the memory, but also have the technical problem of excessive memory occupation and too many times of sorting can be solved, and the number of reading and writing operations on the memory, the memory occupation and the number of times of sorting in the data search process can be reduced.

### Embodiment Three

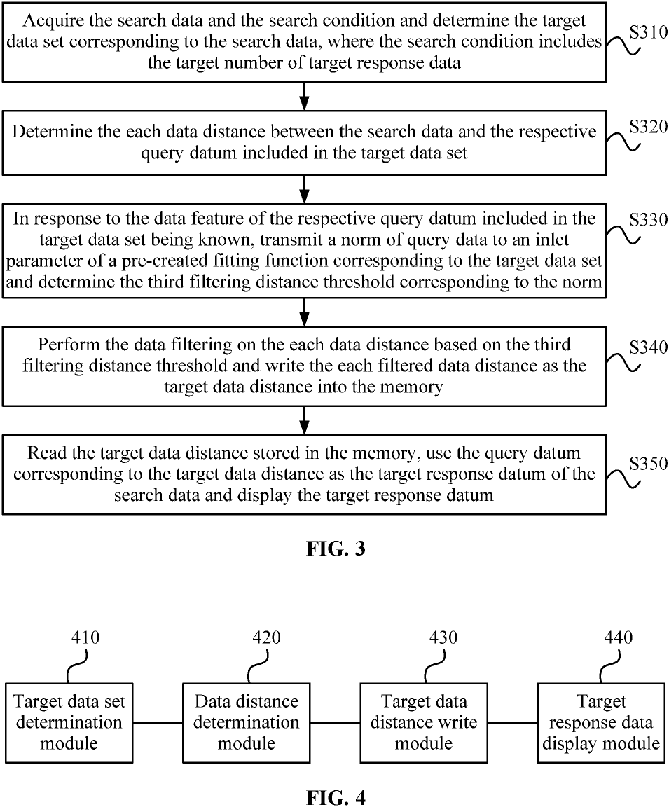

FIG. 3 is a flowchart of a data search method according to embodiment three of the present disclosure. Based on the preceding embodiment, optionally, that the data filtering is performed on the each data distance based on the search condition, and the each filtered data distance as the target data distance is written into the memory includes that in response to the data feature of the respective query datum included in the target data set being known, a norm of query data is transmitted to an inlet parameter of a pre-created fitting function corresponding to the target data set, and the third filtering distance threshold corresponding to the norm is determined, where the fitting function is fitting constructed based on a norm of sample query data and a distance threshold of the sample query data; the data filtering is performed on the each data distance based on the third filtering distance threshold, and the each filtered data distance as the target data distance is written into the memory. Technical terms identical to or corresponding to the preceding embodiment are not repeated here.

As shown in FIG. 3, the method in the present embodiment may specifically include the steps below.

In S310, the search data and the search condition are acquired, and the target data set corresponding to the search data is determined, where the search condition includes the target number of target response data.

In S320, the each data distance between the search data and the respective query datum included in the target data set is determined.

In S330, in response to the data feature of the respective query datum included in the target data set being known, a norm of query data is transmitted to an inlet parameter of a pre-created fitting function corresponding to the target data set, and the third filtering distance threshold corresponding to the norm is determined.

The fitting function is fitting constructed based on a norm of sample query data and a distance threshold of the sample query data. The sample query data may be query data preselected by the user and is used for constructing the fitting function of the target data set. The third filtering distance threshold may be a filtering distance threshold determined based on the pre-created fitting function corresponding to the target data set.

In an embodiment, the fitting function corresponding to the target data set is pre-created. The norm of the query data is determined in response to the data feature of the respective query datum included in the target data set being known. After being determined, the norm of the query data can be transmitted to the pre-created fitting function corresponding to the target data set. After the data transmission is completed, the fitting function can be executed. After the execution of the fitting function is completed, the filtering distance threshold corresponding to the norm of the query data can be determined. Then, the filtering distance threshold corresponding to the norm of the query data can be used as the third filtering distance threshold.

It is to be noted that the construction of the fitting function may be obtained by training the existing training model. The norm of the sample query data is used as the input of the training model, and the distance threshold of the sample query data is used as the output of the training model.

In S340, the data filtering is performed on the each data distance based on the third filtering distance threshold, and the each filtered data distance as the target data distance is written into the memory.

In an embodiment, after the third filtering distance threshold is obtained, the data filtering can be performed on the each data distance based on the third filtering distance threshold to obtain the each filtered data distance. After being obtained, the each filtered data distance can be used as the target data distance. That is, the target data distance is obtained. After being obtained, the target data distance can be written into the memory.

In S350 the target data distance stored in the memory is read, the query datum corresponding to the target data distance is used as the target response datum of the search data, and the target response datum is displayed.

In the technical solution in the present embodiment of the present disclosure, if the search data included in the target data set is of the second type, the norm of the search data is transmitted to the inlet parameter of the pre-created fitting function corresponding to the target data set, and the third filtering distance threshold corresponding to the norm is determined, where the fitting function is fitting constructed based on the norm of the sample query data and the distance threshold of the sample query data; the data filtering is performed on the each data distance based on the third filtering distance threshold, and the each filtered data distance as the target data distance is written into the memory. In this manner, that in the data search process, the existing data search methods not only require frequent reading and writing operations on the memory, but also have the technical problem of excessive memory occupation can be solved, and the number of reading and writing operations on the memory, the memory occupation and the number of times of sorting in the data search process can be reduced.

### Embodiment Four

FIG. 4 is a diagram illustrating the structure of a data search apparatus according to embodiment four of the present disclosure. The present disclosure provides a data search apparatus. The apparatus includes a target data set determination module 410, a data distance determination module 420, a target data distance write module 430 and a target response data display module 440.

The target data set determination module 410 is configured to acquire search data and a search condition and determine a target data set corresponding to the search data. The data distance determination module 420 is configured to determine each data distance between the search data and a respective query datum included in the target data set. The target data distance write module 430 is configured to perform data filtering on the each data distance based on the search condition and write each filtered data distance as a target data distance into a memory. The target response data display module 440 is configured to read the target data distance stored in the memory, use a query datum corresponding to the target data distance as a target response datum of the search data and display the target response datum.

In the technical solution in the present embodiment of the present disclosure, the target data set determination module is configured to acquire the search data and the search condition. Therefore, the target data set corresponding to the search data can be determined according to the search data. After the target data set is determined, the data distance determination module can be configured to determine the each data distance between the search data and the respective query datum included in the target data set. After the each data distance is determined, the target data distance write module can be configured to perform the data filtering on the each data distance based on the search condition to obtain the each filtered data distance. After being obtained, the each filtered data distance as the target data distance can be written into the memory. After the target data distance is written into the memory, the target response data display module can be configured to read the target data distance stored in the memory. After the target data distance is read, the query datum corresponding to the target data distance can be used as the target response datum of the search data, and the target response datum can be displayed. In this manner, the data can be searched, that in the data search process, the existing data search methods not only require frequent reading and writing operations on the memory, but also have the technical problem of excessive memory occupation can be solved, and the number of reading and writing operations on the memory and the memory occupation in the data search process can be reduced.

In an embodiment, the search condition includes the data similarity between the search data and the target response data. The target data distance write module 430 is configured to use the data similarity as the first filtering distance threshold and write each data distance exceeding the first filtering distance threshold as the target data distance into the memory.

In an embodiment, the search condition includes the target number of target response data. The target data distance write module 430 is configured to divide the target data set into at least two to-be-processed data groups in response to the data feature of the respective query datum included in the target data set being unknown; for the first to-be-processed data group of the at least two to-be-processed data groups, perform date filtering on each data distance corresponding to a respective query datum in the to-be-processed data group according to the target number of target response data to obtain the target number of filtered data distances and determine the second filtering distance threshold of the second to-be-processed data group according to each filtered data distance; for the second to-be-processed data group and each subsequent to-be-processed data group of the second to-be-processed data group, perform data filtering on each data distance corresponding to a respective query datum in the current to-be-processed data group according to the second filtering distance threshold of the previous to-be-processed data group of the current to-be-processed data group to obtain the filtered data distances of the current to-be-processed data group, combine the filtered data distances of the current to-be-processed data group with filtered data distances of the previous to-be-processed data group, determine the target number of filtered data distances according to the combined filtered data distances and update the second filtering distance threshold; and write the determined target number of filtered data distances as target data distances into the memory in response to the current to-be-processed data group being the last to-be-processed data group.

In an embodiment, the apparatus further includes a filtering data distance storage module configured to store the filtering data distances into a pre-created queue; and before the filtered data distances of the current to-be-processed data group are combined with the filtered data distances of the previous to-be-processed data group, the apparatus further includes a filtering data distance read module configured to read the filtered data distances of the previous to-be-processed data group of the current to-be-processed data group from the pre-created queue.

In an embodiment, the target data distance write module 430 is configured to sort the data distances corresponding to query data in the to-be-processed data group in a descending order or an ascending order, perform data filtering on the sorted data distances based on the target number of target response data to obtain the target number of filtered data distances and determine the second filtering distance threshold of the second to-be-processed data group according to each filtered data distance.

In an embodiment, the target data distance write module 430 is configured to, in response to the data distances of the query data in the to-be-processed data group being sorted in a descending order, use the target number of top-ranked data distances among the sorted data distances as the target number of filtered data distances of the to-be-processed data group and use a data distance having the minimum value among the sorted data distances of the to-be-processed data group as the second filtering distance threshold of the second to-be-processed data group; in response to the data distances of the query data in the to-be-processed data group being sorted in an ascending order, use the target number of bottom-ranked data distances among the sorted data distances as the target number of filtered data distances of the to-be-processed data group and use the data distance having the minimum value among the sorted data distances of the to-be-processed data group as the second filtering distance threshold of the second to-be-processed data group.

In an embodiment, the target data distance write module 430 is configured to divide the target data set into at least two to-be-processed data groups according to the number of query data.

In an embodiment, the target data distance write module 430 is configured to, in response to the data feature of the respective query datum included in the target data set being known, transmit a norm of query data to an inlet parameter of a pre-created fitting function corresponding to the target data set, determine the third filtering distance threshold corresponding to the norm, where the fitting function is fitting constructed based on a norm of sample query data and a distance threshold of the sample query data; perform the data filtering on the each data distance based on the third filtering distance threshold, and write the each filtered data distance as the target data distance into the memory.

The preceding apparatus can execute the data search method provided in any embodiment of the present disclosure and has functional modules and beneficial effects corresponding to the execution method.

It is to be noted that units and modules included in the preceding data search apparatus are just divided according to functional logic, and the division is not limited to this, as long as the corresponding functions can be implemented. Additionally, the specific names of the functional units are just intended for distinguishing and are not to limit the protection scope of the embodiments of the present disclosure.

### Embodiment Five

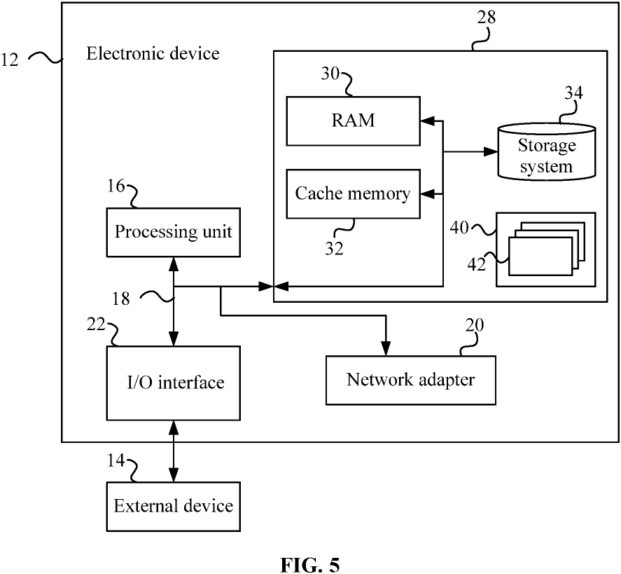

FIG. 5 is a diagram illustrating the structure of an electronic device according to embodiment five of the present disclosure. FIG. 5 shows a block diagram of an exemplary electronic device 12 for performing any embodiment of the present disclosure. The electronic device 12 shown in FIG. 5 is merely an example and is not intended to limit the function and use scope of the embodiments of the present disclosure. The device 12 is typically an electronic device that undertakes the processing of configuration information.

As shown in FIG. 5, the electronic device 12 may take a form of a general-purpose computer device. Components of the electronic device 12 may include, but are not limited to, one or more processors or processing units 16, a memory 28, and a bus 18 connecting different components (including the memory 28 and the one or more processing units 16).

The bus 18 represents one or more of several types of bus architectures, including a memory bus or memory controller, a peripheral bus, an accelerated graphics port, and a processor, or represents a local bus using any one of multiple bus architectures. For example, these architectures include, but are not limited to, an Industry Standard Architecture (ISA) bus, a Micro Channel architecture (MAC) bus, an enhanced ISA bus, a Video Electronics Standards Association (VESA) local bus and a Peripheral Component Interconnect (PCI) bus.

The electronic device 12 typically includes multiple computer-readable media. These media may be available media that can be accessed by the electronic device 12. These media include volatile and non-volatile media, and removable and non-removable media.

The memory 28 may include a computer apparatus readable medium in the form of a volatile memory, such as a random-access memory (RAM) 30 and/or a cache memory 32. The electronic device 12 may further include other removable/non-removable and volatile/non-volatile computer storage media. Just for example, a storage system 34 may be configured to perform reading and writing operations on a non-removable and non-volatile magnetic medium (not shown in the figure and usually referred to as a “hard disk driver”). Although not shown in the figure, it is feasible to provide not only a magnetic disk driver for performing reading and writing operations on a removable non-volatile magnetic disk (for example, a “floppy disk”), but also an optical disk driver for performing reading and writing operations on a removable non-volatile optical disk (for example, a compact disc read-only memory (CD-ROM), a digital video disc-read only memory (DVD-ROM) or other optical media). In such cases, each driver may be connected to the bus 18 via one or more data media interfaces. The memory 28 may include at least one program product 40 having a group of program modules 42. These program modules are configured to perform functions of the embodiments of the present disclosure. The at least one program product 40 may be stored in, for example, the memory 28. These program modules 42 include, but are not limited to, one or more application programs, other program modules and program data. Each or some combination of these examples may include the implementation of a network environment. Each program module 42 generally executes functions and/or methods in the embodiments of the present disclosure.

The electronic device 12 may also communicate with one or more external devices 14 (for example, a keyboard, a mouse, or a camera and a displayer). The electronic device 12 may also communicate with one or more devices that enable the user to interact with the electronic device 12, and/or with any device (for example, a network card or a modem) that enables the electronic device 12 to communicate with one or more other computing devices. These communications may be performed through an input/output (I/O) interface 22. Moreover, the electronic device 12 may also communicate with one or more networks (for example, a local area network (LAN), a wide area network (WAN), and/or a public network, such as the Internet) through a network adapter 20. As shown in the figure, the network adapter 20 communicates with other modules of the electronic device 12 via the bus 18. It is to be understood that though not shown in the figure, other hardware and/or software modules may be used in conjunction with the electronic device 12. The other hardware and/or software modules include, but are not limited to, microcode, a device driver, a redundant processor, an external disk drive array, a redundant arrays of independent disks (RAID) device, a tape driver, or a data backup storage device.

The one or more processing units 16 run a program stored in the memory 28 to perform various functional applications and data processing, for example, to perform the data search method provided in the embodiments of the present disclosure. The method includes the steps below.

Search data and a search condition are acquired. A target data set corresponding to the search data is determined. Each data distance between the search data and a respective query datum included in the target data set is determined. Data filtering is performed on the each data distance based on the search condition, and each filtered data distance as a target data distance is written into a memory. The target data distance stored in the memory is read, a query datum corresponding to the target data distance is used as a target response datum of the search data, and the target response datum is displayed.

Certainly, it is to be understood by those skilled in the art that the processor can also perform the technical solution of the data search method provided in any embodiment of the present disclosure.

### Embodiment Six

Embodiment six of the present disclosure further provides a non-transitory computer-readable storage medium storing a computer program which, when executed by a processor, causes the processor to perform, for example, the data search method provided in the preceding embodiments of the present disclosure. The method includes the steps below.

Search data and a search condition are acquired. A target data set corresponding to the search data is determined. Each data distance between the search data and a respective query datum included in the target data set is determined. Data filtering is performed on the each data distance based on the search condition, and each filtered data distance as a target data distance is written into a memory. The target data distance stored in the memory is read, a query datum corresponding to the target data distance is used as a target response datum of the search data, and the target response datum is displayed.

The computer storage medium of the present embodiment of the present disclosure may use any combination of one or more computer-readable media. The computer-readable media may be computer-readable signal media or computer-readable storage media. The computer-readable storage medium may be, but is not limited to, for example, an electronic, magnetic, optical, electromagnetic, infrared or semiconductor system, apparatus or device or any combination thereof. More specific examples of the computer-readable storage medium include (non-exhaustive list) an electrical connection having one or more wires, a portable computer magnetic disk, a hard disk, a random access memory (RAM), a read only memory (ROM), an erasable programmable read only memory (EPROM or flash memory), an optical fiber, a portable compact disk read only memory (CD-ROM), an optical memory device, a magnetic memory device, or any suitable combination thereof. In this document, the computer-readable storage medium may be any tangible medium including or storing a program. The program may be used by or used in conjunction with an instruction execution system, apparatus, or device.

A computer-readable signal medium may include a data signal propagated in a baseband or as part of a carrier. Computer-readable program codes are carried in the data signal. The data signal propagated in this manner may be in multiple forms and includes, but is not limited to, an electromagnetic signal, an optical signal, or any suitable combination thereof. The computer-readable signal medium may also be any computer-readable medium except the computer-readable storage medium. The computer-readable medium may send, propagate or transmit a program used by or used in conjunction with an instruction execution system, apparatus or device.

Program codes included in the computer-readable medium may be transmitted using any appropriate medium, including, but not limited to, wireless, wireline, optical fiber cable, RF, or any appropriate combinations thereof.

Computer program codes for performing the operations of the embodiments of the present disclosure may be written in one or more programming languages or a combination thereof. These programming languages include object-oriented programming languages, such as Java, Python and C++, as well as conventional procedural programming languages, such as the “C” language, CUDA and OpenCL, or similar programming languages. Program codes may be executed entirely on a user computer, partly on a user computer, as a stand-alone software package, partly on a user computer and partly on a remote computer, or entirely on a remote computer or a server. In the case relating to the remote computer, the remote computer may be connected to the user computer via any type of network including a local area network (LAN) or a wide area network (WAN), or may be connected to an external computer (for example, via the Internet through an Internet service provider).

It is to be noted that the preceding are only preferred embodiments of the present disclosure and technical principles used therein. It is to be understood by those skilled in the art that the present disclosure is not limited to the embodiments described herein. Those skilled in the art can make various apparent modifications, adaptations and substitutions without departing from the scope of the present disclosure. Therefore, while the present disclosure has been described in detail through the preceding embodiments, the present disclosure is not limited to the preceding embodiments and may include more other equivalent embodiment without departing from the concept of the present disclosure. The scope of the present disclosure is determined by the scope of the appended claims.

What is claimed is:

1. A data search method, comprising:
acquiring search data and a search condition and determining a target data set corresponding to the search data;
determining each data distance between the search data and a respective query datum comprised in the target data set;
performing data filtering on the each data distance based on the search condition and writing each filtered data distance as a target data distance into a memory; and
reading the target data distance stored in the memory, using a query datum corresponding to the target data distance as a target response datum of the search data and displaying the target response datum.

2. The method according to claim 1, wherein the search condition comprises data similarity between the search data and the target response datum, and performing the data filtering on the each data distance based on the search condition and writing the each filtered data distance as the target data distance into the memory comprise:
using the data similarity as a first filtering distance threshold and writing each data distance greater than or equal to the first filtering distance threshold as the target data distance into the memory or writing each data distance less than or equal to the first filtering distance threshold as the target data distance into the memory.

3. The method according to claim 1, wherein the search condition comprises a target number of target response data, and performing the data filtering on the each data distance based on the search condition and writing the each filtered data distance as the target data distance into the memory comprise:
in response to a data feature of the respective query datum comprised in the target data set being unknown, dividing the target data set into at least two to-be-processed data groups;
for a first to-be-processed data group of the at least two to-be-processed data groups, performing data filtering on each data distance corresponding to a respective query datum in the first to-be-processed data group according to the target number of target response data to obtain the target number of filtered data distances and determining a second filtering distance threshold of a second to-be-processed data group of the at least two to-be-processed data groups according to each of the target number of filtered data distances;
for each of the second to-be-processed data group and remaining to-be-processed data groups of the at least two to-be-processed data groups, performing data filtering on each data distance corresponding to a respective query datum in a current to-be-processed data group according to a second filtering distance threshold of a previous to-be-processed data group of the current to-be-processed data group to obtain filtered data distances of the current to-be-processed data group, combining the filtered data distances of the current to-be-processed data group with filtered data distances of the previous to-be-processed data group, determining the target number of filtered data distances according to the combined filtered data distances and updating the second filtering distance threshold; and
in response to the current to-be-processed data group being a last to-be-processed data group, writing the determined target number of filtered data distances as target data distances into the memory.

4. The method according to claim 3, further comprising:
storing the filtered data distances of the current to-be-processed data group into a pre-created queue; and
wherein before combining the filtered data distances of the current to-be-processed data group with the filtered data distances of the previous to-be-processed data group, the method further comprises:
reading the filtered data distances of the previous to-be-processed group of the current to-be-processed data group from the pre-created queue.

5. The method according to claim 3, wherein performing the data filtering on the each data distance corresponding to the respective query datum in the first to-be-processed data group according to the target number of target response data to obtain the target number of filtered data distances and determining the second filtering distance threshold of the second to-be-processed data group according to the each of the target number of filtered data distances comprise:
sorting data distances corresponding to query data in the to-be-processed data group in a descending order or an ascending order; and
performing data filtering on the sorted data distances based on the target number of target response data to obtain the target number of filtered data distances and determining the second filtering distance threshold of the second to-be-processed data group according to the each of the target number of filtered data distances.

6. The method according to claim 5, wherein performing the data filtering on the sorted data distances based on the target number of target response data to obtain the target number of filtered data distances and determining the second filtering distance threshold of the second to-be-processed data group according to the each of the target number of filtered data distances comprise:
in response to the data distances of the query data in the to-be-processed data group being sorted in the descending order, using the target number of top-ranked data distances among the sorted data distances as the target number of filtered data distances of the to-be-processed data group and using a data distance having a minimum value among the sorted data distances of the to-be-processed data group as the second filtering distance threshold of the second to-be-processed data group; or
in response to the data distances of the query data in the to-be-processed data group being sorted in the ascending order, using the target number of top-ranked data distances among the sorted data distances as the target number of filtered data distances of the to-be-processed data group and using a data distance having the maximum value among the sorted data distances of the to-be-processed data group as the second filtering distance threshold of the second to-be-processed data group.

7. The method according to claim 3, wherein dividing the target data set into the at least two to-be-processed data groups comprises:
dividing the target data set into the at least two to-be-processed data groups according to a number of query data in the target data set.

8. The method according to claim 3, wherein performing the data filtering on the each data distance based on the search condition and writing the each filtered data distance as the target data distance into the memory comprise:
in response to the data feature of the respective query datum comprised in the target data set being known, transmitting a norm of query data in the target data set to an inlet parameter of a pre-created fitting function corresponding to the target data set and determining a third filtering distance threshold corresponding to the norm, wherein the fitting function is fitting constructed based on a norm of sample query data and a distance threshold of the sample query data; and
performing data filtering on the each data distance based on the third filtering distance threshold and writing the each filtered data distance as the target data distance into the memory.

9. A data search apparatus, comprising:
at least one processor; and
a storage apparatus configured to store at least one program;
wherein the at least one program, when executed by the at least one processor, causes the at least one processor to:
obtain search data and a search condition and determine a target data set corresponding to the search data;
determine each data distance between the search data and a respective query datum comprised in the target data set;
perform data filtering on the each data distance based on the search condition and write each filtered data distance as a target data distance into a memory; and
read the target data distance stored in the memory, use a query datum corresponding to the target data distance as a target response datum of the search data and display the target response datum.

10. A non-transitory computer-readable storage medium storing a computer program, wherein the computer program, when executed by a processor, implements:
acquiring search data and a search condition and determining a target data set corresponding to the search data;
determining each data distance between the search data and a respective query datum comprised in the target data set;
performing data filtering on the each data distance based on the search condition and writing each filtered data distance as a target data distance into a memory; and
reading the target data distance stored in the memory, using a query datum corresponding to the target data distance as a target response datum of the search data and displaying the target response datum.

11. The data search apparatus according to claim 9, wherein the search condition comprises data similarity between the search data and the target response datum, and the at least one program, when executed by the at least one processor, causes the at least one processor to implement:
using the data similarity as a first filtering distance threshold and writing each data distance greater than or equal to the first filtering distance threshold as the target data distance into the memory or writing each data distance less than or equal to the first filtering distance threshold as the target data distance into the memory.

12. The data search apparatus according to claim 9, wherein the search condition comprises a target number of target response data, and the at least one program, when executed by the at least one processor, causes the at least one processor to implement:
in response to a data feature of the respective query datum comprised in the target data set being unknown, dividing the target data set into at least two to-be-processed data groups;
for a first to-be-processed data group of the at least two to-be-processed data groups, performing data filtering on each data distance corresponding to a respective query datum in the first to-be-processed data group according to the target number of target response data to obtain the target number of filtered data distances and determining a second filtering distance threshold of a second to-be-processed data group of the at least two to-be-processed data groups according to each of the target number of filtered data distances;
for each of the second to-be-processed data group and remaining to-be-processed data groups of the at least two to-be-processed data groups, performing data filtering on each data distance corresponding to a respective query datum in a current to-be-processed data group according to a second filtering distance threshold of a previous to-be-processed data group of the current to-be-processed data group to obtain filtered data distances of the current to-be-processed data group, combining the filtered data distances of the current to-be-processed data group with filtered data distances of the previous to-be-processed data group, determining the target number of filtered data distances according to the combined filtered data distances and updating the second filtering distance threshold; and
in response to the current to-be-processed data group being a last to-be-processed data group, writing the determined target number of filtered data distances as target data distances into the memory.

13. The data search apparatus according to claim 12, wherein the at least one program, when executed by the at least one processor, causes the at least one processor to implement:
storing the filtered data distances of the current to-be-processed data group into a pre-created queue; and
wherein before combining the filtered data distances of the current to-be-processed data group with the filtered data distances of the previous to-be-processed data group, the method further comprises:
reading the filtered data distances of the previous to-be-processed group of the current to-be-processed data group from the pre-created queue.

14. The data search apparatus according to claim 12, wherein the at least one program, when executed by the at least one processor, causes the at least one processor to implement:
sorting data distances corresponding to query data in the to-be-processed data group in a descending order or an ascending order; and
performing data filtering on the sorted data distances based on the target number of target response data to obtain the target number of filtered data distances and determining the second filtering distance threshold of the second to-be-processed data group according to the each of the target number of filtered data distances.

15. The data search apparatus according to claim 14, wherein the at least one program, when executed by the at least one processor, causes the at least one processor to implement:
in response to the data distances of the query data in the to-be-processed data group being sorted in the descending order, using the target number of top-ranked data distances among the sorted data distances as the target number of filtered data distances of the to-be-processed data group and using a data distance having a minimum value among the sorted data distances of the to-be-processed data group as the second filtering distance threshold of the second to-be-processed data group; or
in response to the data distances of the query data in the to-be-processed data group being sorted in the ascending order, using the target number of top-ranked data distances among the sorted data distances as the target number of filtered data distances of the to-be-processed data group and using a data distance having the maximum value among the sorted data distances of the to-be-processed data group as the second filtering distance threshold of the second to-be-processed data group.

16. The data search apparatus according to claim 12, wherein the at least one program, when executed by the at least one processor, causes the at least one processor to implement:
dividing the target data set into the at least two to-be-processed data groups according to a number of query data in the target data set.

17. The data search apparatus according to claim 12, wherein the at least one program, when executed by the at least one processor, causes the at least one processor to implement:
in response to the data feature of the respective query datum comprised in the target data set being known, transmitting a norm of query data in the target data set to an inlet parameter of a pre-created fitting function corresponding to the target data set and determining a third filtering distance threshold corresponding to the norm, wherein the fitting function is fitting constructed based on a norm of sample query data and a distance threshold of the sample query data; and
performing data filtering on the each data distance based on the third filtering distance threshold and writing the each filtered data distance as the target data distance into the memory.

18. The non-transitory computer-readable storage medium according to claim 10, wherein the search condition comprises data similarity between the search data and the target response datum, and the computer program, when executed by the processor, implements:
using the data similarity as a first filtering distance threshold and writing each data distance greater than or equal to the first filtering distance threshold as the target data distance into the memory or writing each data distance less than or equal to the first filtering distance threshold as the target data distance into the memory.

19. The non-transitory computer-readable storage medium according to claim 10, wherein the search condition comprises a target number of target response data, and the computer program, when executed by the processor, implements:
in response to a data feature of the respective query datum comprised in the target data set being unknown, dividing the target data set into at least two to-be-processed data groups;
for a first to-be-processed data group of the at least two to-be-processed data groups, performing data filtering on each data distance corresponding to a respective query datum in the first to-be-processed data group according to the target number of target response data to obtain the target number of filtered data distances and determining a second filtering distance threshold of a second to-be-processed data group of the at least two to-be-processed data groups according to each of the target number of filtered data distances;
for each of the second to-be-processed data group and remaining to-be-processed data groups of the at least two to-be-processed data groups, performing data filtering on each data distance corresponding to a respective query datum in a current to-be-processed data group according to a second filtering distance threshold of a previous to-be-processed data group of the current to-be-processed data group to obtain filtered data distances of the current to-be-processed data group, combining the filtered data distances of the current to-be-processed data group with filtered data distances of the previous to-be-processed data group, determining the target number of filtered data distances according to the combined filtered data distances and updating the second filtering distance threshold; and
in response to the current to-be-processed data group being a last to-be-processed data group, writing the determined target number of filtered data distances as target data distances into the memory.

20. The non-transitory computer-readable storage medium according to claim 19, wherein the computer program, when executed by the processor, implements:
storing the filtered data distances of the current to-be-processed data group into a pre-created queue; and
wherein before combining the filtered data distances of the current to-be-processed data group with the filtered data distances of the previous to-be-processed data group, the method further comprises:
reading the filtered data distances of the previous to-be-processed group of the current to-be-processed data group from the pre-created queue.
